(19) United States
(12) Patent Application Publication
(10) Pub. No.: US 2026/0355049 A1
(43) Pub. Date: Nov. 12, 2026

(54) MASSAGE DEVICE

(71) Applicant: Shenzhen Mofandika Co., Ltd., Shenzhen (CN)

(72) Inventor: Dong MO, Shenzhen (CN)

(21) Appl. No.: 19/724,953

(22) Filed: Jun. 30, 2026

(30) Foreign Application Priority Data
Jun. 16, 2026 (CN) 202620901455.9

(51) Int. Cl. A61H 15/00

(52) U.S. Cl. CPC A61H 15/00; A61H 2015/0014; A61H 2201/0149; A61H 2201/0192; A61H 2201/1669; A61H 2203/0431

(57) ABSTRACT

A massage device, including: a bracket, a massage assembly mounted on the bracket and a sliding seat slidably connected with the bracket. The massage assembly is configured to massage a body part to be massaged of a human body. The sliding seat is configured to support a supporting part of the human body. The sliding seat is configured to slide back and forth relative to the massage assembly, when the supporting part of the human body rests on the sliding seat and the body part to be massaged contacts the massage assembly, relative motion between the body part to be massaged and the massage assembly is generated to massage or stretch the body part to be massaged.

### CROSS REFERENCE TO RELATED APPLICATIONS

This application claims priority to Chinese Patent Application No. 202620901455.9, filed on Jun. 16, 2026 in the China National Intellectual Property Administration, the entire disclosure of which is hereby incorporated by reference.

### TECHNICAL FIELD

The present disclosure relates to the technical field of massage equipment, in particular to a massage device.

### BACKGROUND

Massage rollers, foam rollers, and other massage tools are generally used for massaging and relaxing parts of the human body such as the back, waist, buttocks, and legs. Existing massage rollers are generally independent cylindrical rollers. In use, the massage roller is placed on the ground, a yoga mat, or another supporting surface; the body part to be massaged of the human body abuts against the outer peripheral surface of the massage roller; and the human body then moves forward and backward or reciprocates by itself, causing the massage roller to produce a rolling or pressing action relative to the human body, thereby achieving the effects of massage, relaxation, or stretching.

During use of existing massage rollers, the human body needs to move back and forth above or beside the massage roller, while the massage roller itself only forms local abutment with the portion to be massaged and cannot provide stable support points for other body parts to be massaged. In order to enable the body to smoothly reciprocate relative to the massage roller, the user typically needs to exert additional force through parts such as the arms, waist and abdomen, and legs to maintain body balance and support body weight. In particular, when massaging the back, waist, buttocks, and other portions, the human body often needs to maintain a suspended or semi-suspended posture and complete forward and backward movements in this posture. There is a lack of structures capable of providing support and guidance for the human body. During the reciprocating movement, the user is prone to problems such as body shaking, unstable support, or unsmooth movement, resulting in a relatively laborious massage process that imposes high requirements on the user's strength and balance control.

### SUMMARY

To realize the above objective, the present disclosure provides a massage device, including: a bracket; a massage assembly mounted on the bracket, the massage assembly is configured to massage a body part to be massaged of a human body; a sliding seat slidably connected with the bracket, the sliding seat is configured to support a supporting part of the human body; wherein the sliding seat is configured to slide back and forth relative to the massage assembly, when the supporting part of the human body rests on the sliding seat and the body part to be massaged contacts the massage assembly, relative motion between the body part to be massaged and the massage assembly is generated to massage or stretch the body part to be massaged.

In one embodiment, the bracket includes a slide rail guide portion along a first direction, and the massage assembly includes a sliding block slidably connected to the slide rail guide portion, whereby a mounting position of the massage assembly is adjustable along the first direction of the bracket.

In one embodiment, the bracket is provided with a plurality of positioning portions, the massage assembly further includes a clamping portion configured to detachably engage with any one of the plurality of positioning portions.

In one embodiment, the massage assembly further includes a rotating shaft, and the massage assembly is rotatably mounted on the bracket through the rotating shaft.

In one embodiment, the massage assembly further includes at least one massage roller.

In one embodiment, a plurality of massage protrusions are provided on an outer periphery of the massage assembly.

In one embodiment, the bracket is provided with a guide rail, and the sliding seat includes a mounting portion on a side facing the bracket, the mounting portion being slidably engaged with the guide rail.

In one embodiment, further including an angle adjusting assembly configured to selectively adjust at least one of: an inclination angle of the massage assembly relative to a horizontal plane; and an inclination angle of the sliding seat relative to the horizontal plane.

In one embodiment, the angle adjusting assembly is disposed at one end of the bracket proximate to the sliding seat.

In one embodiment, the angle adjusting assembly includes a telescopic rod and a locking knob; the telescopic rod defines a strip-shaped slot extending along a length direction thereof; the bracket defines a through hole aligned with the strip-shaped slot; the locking knob passes through the through hole and the strip-shaped slot to selectively lock the telescopic rod at different extension lengths relative to the bracket.

In one embodiment, the angle adjusting assembly includes a supporting foot, an adjustment disk fixed to the bracket, and a pivot shaft; the supporting foot is rotatably connected with the adjustment disk via the pivot shaft, the supporting foot being configured to pivot relative to the bracket between an expanded position and a retracted position.

In one embodiment, the adjustment disk defines an arc-shaped guide slot centered on the pivot shaft, the arc-shaped guide slot being provided with a plurality of positioning recesses spaced apart along a circumferential direction; the supporting foot includes a locking portion configured to selectively engage any one of the plurality of positioning recesses through the arc-shaped guide slot, thereby locking the supporting foot in the expanded position at a desired angular position relative to the bracket.

In one embodiment, the angle adjusting assembly further includes a hinge shaft, an adjustment groove and a fixing knob; the bracket further includes a base bracket and a movable bracket hinged by the hinge shaft; wherein the adjustment groove is provided at one end of the base bracket close to a hinge position, and the fixing knob extends through the adjustment groove and is connected with the movable bracket.

In one embodiment, the bracket further includes a supporting frame, and the massage assembly is mounted on the supporting frame so as to form a gap between the massage assembly and the horizontal plane.

The massage device of the present disclosure disposes a massage assembly on a bracket and slidably connects a sliding seat for supporting body part to be massaged to the bracket. This enables the human body, during use, to support the head, neck, buttocks, elbows, or other supporting parts of the human body on the sliding seat while allowing the back, waist, legs, and other body parts to be massaged to abut against the massage assembly. As a result, the sliding seat can provide stable support points for the human body, so that during reciprocating movement the human body no longer needs to completely rely on its own strength to maintain balance and support body weight, thereby reducing the additional effort required by the user during the massaging or stretching process.

At the same time, because the sliding seat can reciprocate relative to the massage assembly, the body parts to be massaged can move in a predetermined direction under the support of the sliding seat, thereby assisting in producing stable relative displacement between the human body and the massage assembly. Compared with the conventional massage device in which a massage roller is placed directly on the ground and the user must independently control the forward and backward movement of the body, the present disclosure can reduce shaking and unstable support of the human body during reciprocating movement, enable the human body to move back and forth more smoothly, and improve the continuity, stability, and comfort of the massage process.

### BRIEF DESCRIPTION OF THE DRAWINGS

FIG. 1 is a schematic structural diagram of a massage device according to one embodiment of the present disclosure;

FIG. 2 is a side view of the massage device according to one embodiment of the present disclosure;

FIG. 3 is a partial exploded view of the massage device according to one embodiment of the present disclosure;

FIG. 4 is a top view of the massage device according to a first embodiment of the present disclosure;

FIG. 5 is a partially enlarged view of the massage device according to one embodiment of the present disclosure;

FIG. 6 is a schematic structural diagram of the massage device according to the first embodiment of the present disclosure;

FIG. 7 is a partial schematic structural diagram of the massage device according to the first embodiment of the present disclosure;

FIG. 8 is a schematic structural diagram of a massage assembly of the massage device according to one embodiment of the present disclosure;

FIG. 9 is a schematic structural diagram of the massage assembly of the massage device according to one embodiment of the present disclosure;

FIG. 10 is a schematic structural diagram of an angle adjusting assembly of the massage device according to one embodiment of the present disclosure, which shows a second adjustment mode;

FIG. 11 is a schematic structural diagram of the angle adjusting assembly of the massage device according to one embodiment of the present disclosure, which shows a third adjustment mode;

FIG. 12 is a partially enlarged view of the angle adjusting assembly of the massage device according to one embodiment of the present disclosure, which shows a third adjustment mode;

FIG. 13 is a schematic structural diagram of the massage device according to a second embodiment of the present disclosure;

FIG. 14 is a schematic structural diagram of the massage device according to a third embodiment of the present disclosure;

FIG. 15 is a schematic structural diagram of the massage device according to a fourth embodiment of the present disclosure;

FIG. 16 is a schematic structural diagram of the present embodiment of the massage device according to one embodiment of the present disclosure.

### DESCRIPTION OF THE REFERENCE NUMERALS

100, bracket; 110, sliding rail guide portion; 120, positioning portion; 130, guide rail; 150, supporting frame; 160, base bracket; 170, movable bracket;
200, massage assembly; 210, sliding block; 220, clamping portion; 230, rotating shaft; 240, massage roller; 250, massage protrusion;
300, sliding seat; 310, mounting portion; 320, limiting portion;
400, angle adjusting assembly; 410, telescopic rod; 411, strip-shaped slot; 420, locking knob; 430, supporting foot; 440, adjustment disk; 441, arc-shaped guide slot; 442, positioning recess; 450, pivot shaft; 460, locking portion; 470, hinge shaft; 480, adjustment groove; 490, fixing knob; and
500, through hole.

The realization of the objectives, functional features, and advantages of the present disclosure will be further described in conjunction with the embodiments with reference to the accompanying drawings.

### DETAILED DESCRIPTION OF THE EMBODIMENTS

It should be understood that the specific embodiments described herein are merely for explaining the present disclosure and are not intended to limit the present disclosure.

In the description of the present disclosure, it should be understood that the terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” and the like indicate orientations or positional relationships based on the orientations or positional relationships shown in the drawings, and are merely for the convenience of describing the present disclosure and simplifying the description, rather than indicating or implying that the device or element referred to must have a specific orientation, be constructed and operated in a specific orientation, and therefore cannot be understood as a limitation on the present disclosure. In addition, the terms “first” and “second” are used for descriptive purposes only and cannot be understood as indicating or implying relative importance or implicitly indicating the number of technical features indicated. Thus, features defined as “first” and “second” may explicitly or implicitly include one or more of the described features. In the description of the present disclosure, “plurality” means two or more, unless otherwise expressly and specifically limited.

In the description of the present disclosure, it should be noted that, unless otherwise expressly specified and limited, the terms “mounted,” “connected,” and “installed” should be understood in a broad sense; for example, they may be fixed connections, detachable connections, or integral connections; they may be mechanical connections or electrical connections; they may be direct connections or indirect connections through an intermediate medium; and they may be internal communication between two elements or an interaction relationship between two elements. For those of ordinary skill in the art, the specific meanings of the above terms in the present disclosure can be understood according to specific circumstances.

In the present disclosure, unless otherwise expressly specified and limited, when a first feature is described as being “on” or “under” a second feature, this may include direct contact between the first and second features, or contact through another feature between them. Moreover, when a first feature is described as being “above,” “over,” or “on” a second feature, this includes the first feature being directly above or obliquely above the second feature, or merely indicates that the first feature is horizontally higher than the second feature. When a first feature is described as being “below,” “under,” or “beneath” a second feature, this includes the first feature being directly below or obliquely below the second feature, or merely indicates that the first feature is horizontally lower than the second feature.

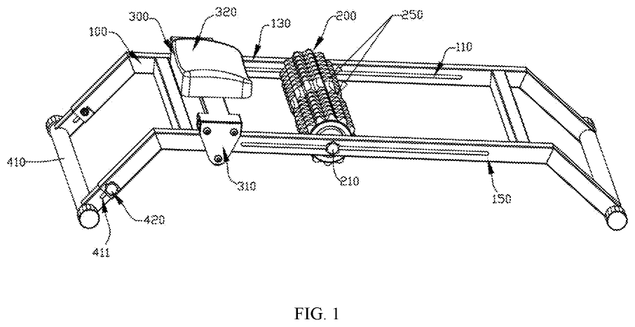

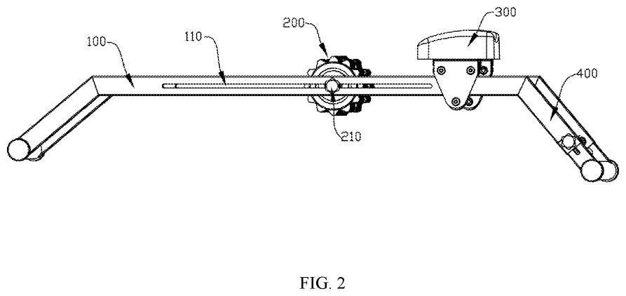

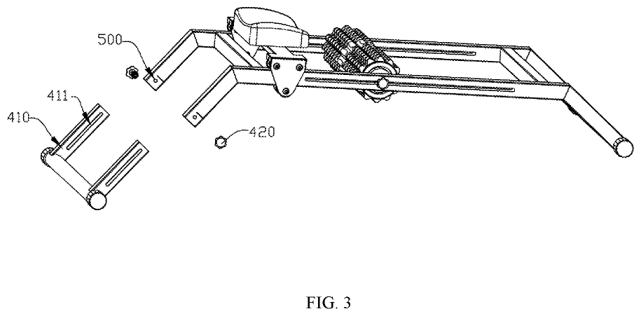

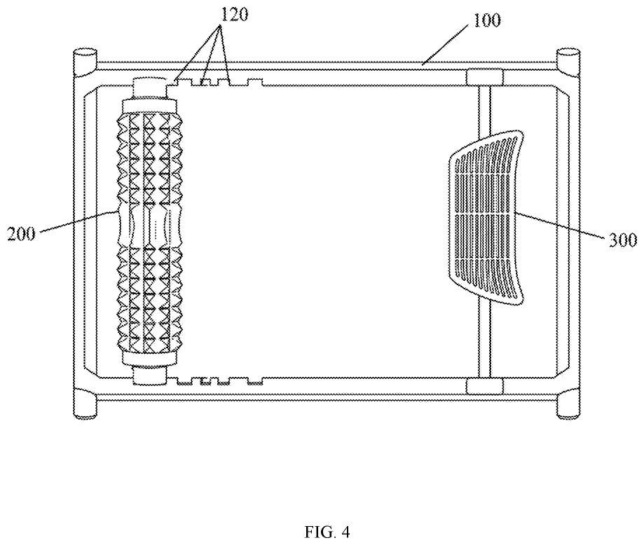

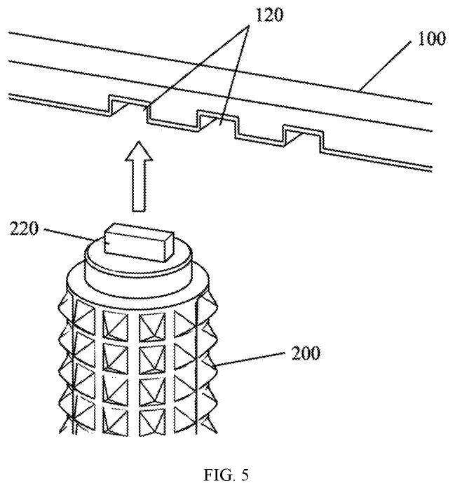

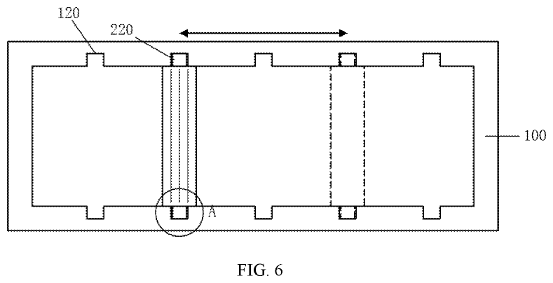

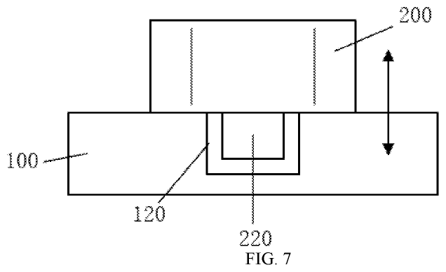

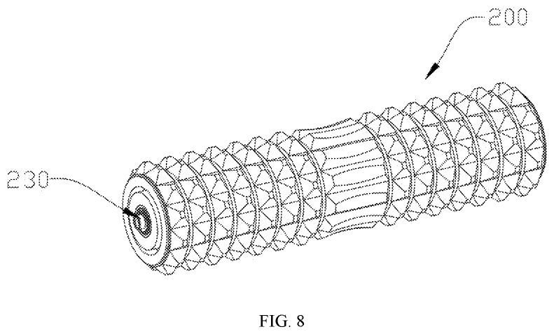

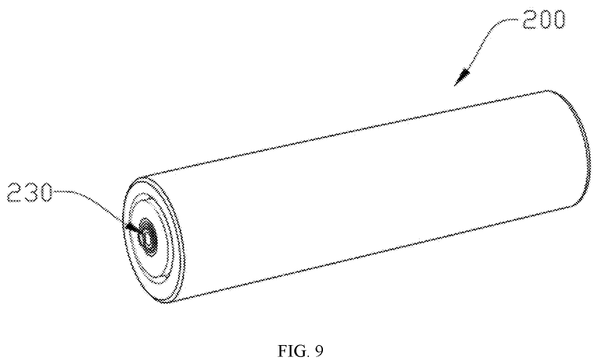

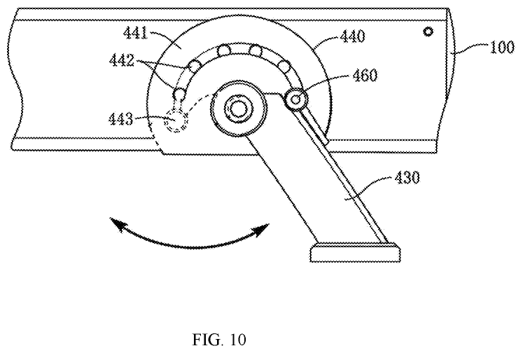

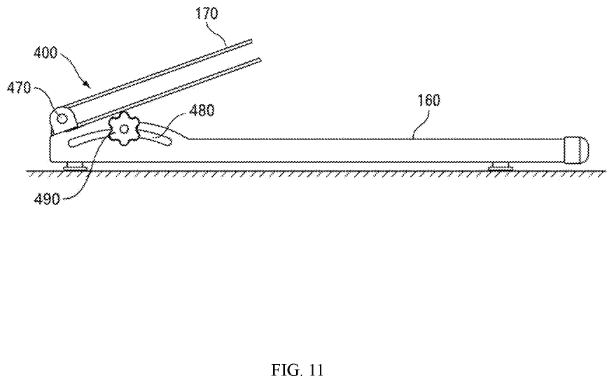

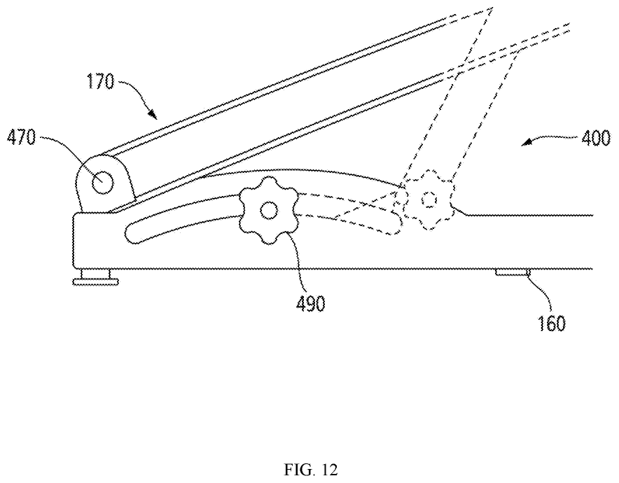

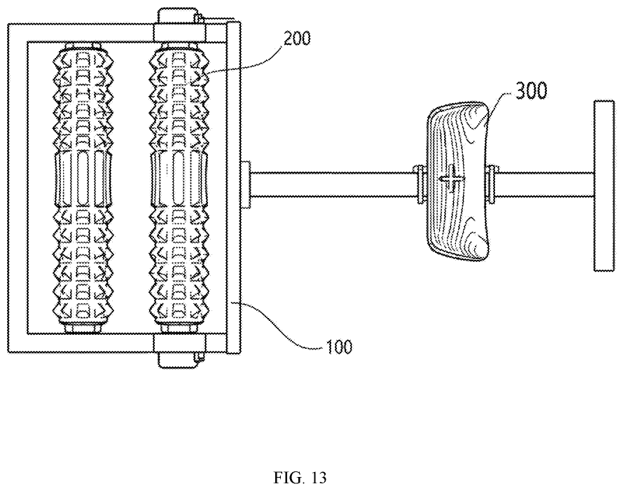

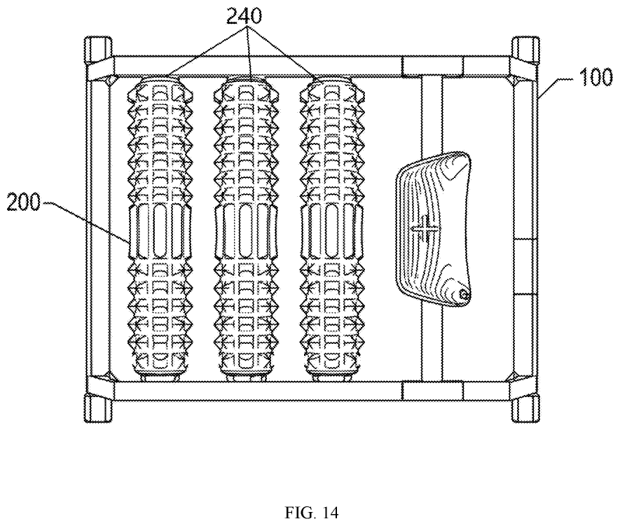

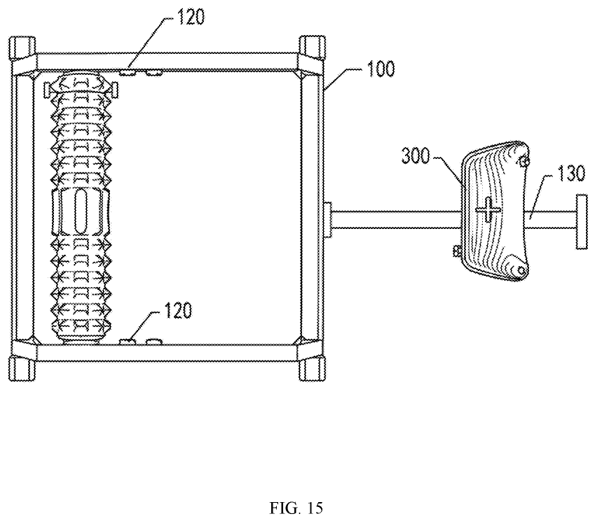

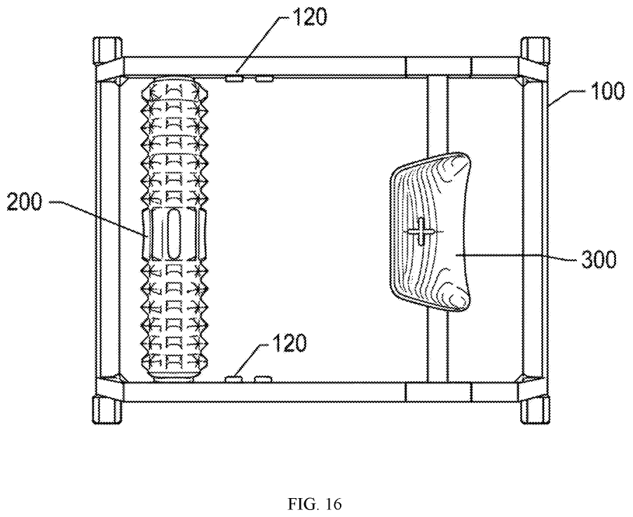

Referring to FIGS. 1 to 16, the present disclosure provides a massage device, including a bracket 100, a massage assembly 200 and a sliding seat 300. The massage assembly 200 is arranged on the bracket 100 and is configured to massage a body part to be massaged of a human body. The sliding seat 300 is slidably connected with the bracket 100 and is configured to support the supporting part of the human body, the sliding seat 300 is capable of reciprocating relative to the massage assembly 200, so that when the supporting part of the human body is supported on the sliding seat 300 and the body part to be massaged of the human body abuts against the massage assembly 200, relative motion is assisted to be generated between the human body and the massage assembly 200, thereby massaging or stretching the body part to be massaged of the human body.

In use, the bracket 100 is placed on the ground, a yoga mat, a bed surface or other horizontal plane. The supporting part of the human body rests on the sliding seat 300, while the body part to be massaged abuts against the massage assembly 200. The supporting part of the human body may be the head, neck, shoulder, buttocks, elbow, arm or other body parts capable of forming support. The body part to be massaged of the human body may be the back, waist, buttocks, legs, shoulder and neck, arms or other parts. Since the sliding seat 300 is capable of reciprocating along the bracket 100 relative to the massage assembly 200, the human body can move back and forth while being supported by the sliding seat 300, so that relative displacement is generated between the human body and the massage assembly 200, thereby achieving massage, relaxation or stretching. Compared with the conventional method of directly placing a massage roller 240 on a horizontal plane, the present embodiment provides a stable support point for the human body, reduces the additional force exerted by the user to maintain balance and support the body, enables smoother back-and-forth movement, and improves the massage or stretching effect.

In some embodiments, the bracket 100 may be a frame-type bracket, a rod-type bracket, a foldable bracket or a detachable bracket. The frame-type bracket may include two side rods arranged opposite to each other and a cross rod connected between the two side rods to form a relatively stable load-bearing structure. The rod-type bracket may include one or more support rods extending along the sliding direction for slidably mounting the sliding seat 300. The foldable bracket can be unfolded and folded through a hinged structure so as to facilitate storage and carrying. The detachable bracket may be formed by detachably connecting a plurality of bracket segments, connecting rods, plug-in connectors or fasteners, so as to facilitate transportation, assembly and maintenance. The above brackets can serve as a mounting base for the massage assembly 200 and the sliding seat 300.

In some embodiments, the massage assembly 200 is arranged on the bracket 100. The massage assembly 200 may be a massage roller shaft, a massage roller wheel, a massage roller 240, a massage ball set, a roller with massage protrusions 250 on the outer periphery, or a massage assembly formed by combining a plurality of massage rollers 240. The massage roller shaft may be substantially cylindrical as a whole for forming continuous rolling massage. The massage roller wheel may be one or more wheel-shaped members arranged at intervals in the transverse direction. The massage roller 240 may have a smooth outer peripheral surface, a wavy outer peripheral surface or a convex-point outer peripheral surface. The massage ball set may include a plurality of rotatable massage balls to adapt to curved parts of the human body. The massage assembly 200 is made of foam, rubber, silica gel, plastic, metal or composite material, and its outer periphery may be provided with massage protrusions 250, massage textures, massage grooves or a soft covering layer to improve massage comfort and massage effect.

In some embodiments, the massage assembly 200 is provided with a rotating shaft 230, and the massage assembly 200 is rotatably arranged on the bracket 100 through the rotating shaft 230. When the body part to be massaged of the human body abuts against the massage assembly 200 and moves relative to the massage assembly 200, the massage assembly 200 is capable of rotating around the rotating shaft 230, so as to reduce sliding friction between the human body and the massage assembly 200 and form a rolling-type massage effect. The massage assembly 200 may include one massage roller 240, or may include a plurality of massage rollers 240. The plurality of massage rollers 240 may be arranged at intervals along the length direction, width direction or inclined direction of the bracket 100 to form different massage coverage areas.

In some embodiments, the bracket 100 is provided with a slide rail guide portion 110 along a first direction, and the massage assembly 200 is provided with a sliding block 210 that is in sliding connection with the slide rail guide portion 110, so that the massage assembly 200 can adjust its mounting position along the first direction of the bracket 100. The first direction may be the length direction of the bracket 100. Through this structure, the massage assembly 200 can change its mounting position relative to the sliding seat 300, so as to adapt to users of different heights and body types, or adapt to different body parts to be massaged such as the back, waist, buttocks and legs.

In another embodiment, the bracket 100 is provided with a plurality of positioning portions 120, and the massage assembly 200 is provided with a clamping portion 220. The clamping portion 220 can be selectively and detachably connected with any one of the positioning portions 120. The positioning portion 120 may be a positioning hole, a positioning groove, a clamping groove, a positioning protrusion, a buckle position or a limiting recess. The clamping portion 220 may be a buckle, a plug-in post, a clamping groove, an elastic clamping member or a connecting structure matching with the positioning portion 120. The user can install the massage assembly 200 at different positioning portions 120, thereby realizing adjustment of the mounting position of the massage assembly 200.

In some embodiments, the bracket 100 is provided with a supporting frame 150, and the massage assembly 200 is mounted on the supporting frame 150, so that a gap is formed between the massage assembly 200 and the horizontal plane. The supporting frame 150 may be a raised seat, a supporting arm or a mounting cross beam on the bracket 100. After the massage assembly 200 is mounted on the supporting frame 150, a gap exists between its lower side and the horizontal plane, so that the massage assembly 200 has an avoidance space when being pressed by the human body and rotating, thereby solving the problem that the massage assembly 200 directly contacts the horizontal plane and affects rotation, and at the same time enabling the massage assembly 200 to maintain an appropriate massage height.

In some embodiments, the bracket 100 is provided with a guide rail 130, and a side of the sliding seat 300 facing the bracket 100 is provided with a mounting portion 310. The mounting portion 310 is slidably connected to the guide rail 130. The guide rail 130 may be a single guide rail, double guide rails, a sliding groove, a guide rod, a guide rail or a roller guide structure. The mounting portion 310 may be a slider, a sliding sleeve, a roller seat, a guide groove or a guide member capable of cooperating with the guide rail 130. Through the cooperation of the guide rail 130 and the mounting portion 310, the sliding seat 300 can reciprocate along a predetermined direction, thereby providing stable support and movement guidance for the supporting part of the human body.

In some embodiments, the sliding seat 300 may be a headrest seat, a neck support seat, a buttock support seat, an elbow support seat, a shoulder support seat or other human body supporting seats. The shape of the sliding seat 300 can be adjusted according to the supporting part of the human body For example, when used for supporting the head or neck, the sliding seat 300 may be provided with an arc-shaped concave surface. When used for supporting the buttocks or elbows, the sliding seat 300 may be provided with a wider supporting surface.

Further, the sliding seat 300 may be provided with a limiting portion 320. The limiting portion 320 is configured to limit lateral deviation of the body part to be massaged relative to the sliding seat 300. The limiting portion 320 may be a soft cushion, an arc-shaped supporting surface, a recessed supporting surface or an elastic covering layer to improve comfort when the body part to be massaged is placed. Through the limiting portion 320, the body part to be massaged can be relatively stable maintained on the sliding seat 300, reducing the situation in which the body part to be massaged sways left and right or disengages from the sliding seat 300 during the reciprocating movement of the sliding seat 300, thereby further improving stability and safety during use.

In some embodiments, the bracket 100 is provided with an angle adjusting assembly 400. The angle adjusting assembly 400 is configured to adjust the included angle of the massage assembly 200 and/or the sliding seat 300 relative to the horizontal plane. By adjusting the usage angle of the bracket 100, the supporting posture of the human body on the sliding seat 300 and the contact angle between the body part to be massaged of the human body and the massage assembly 200 can be changed, thereby adapting to massage or stretching requirements of different parts. The angle adjusting assembly 400 may be arranged at one end of the bracket 100 and close to the sliding seat 300, so as to facilitate changing the overall usage angle of the massage device by adjusting the height or expanding angle of one end of the bracket 100.

In one embodiment, the angle adjusting assembly 400 includes a telescopic rod 410 and a locking knob 420. The telescopic rod 410 is provided with a strip-shaped slot 411 extending along its length direction. The bracket 100 is provided with a through hole 500 corresponding to the strip-shaped slot 411. The locking knob 420 passes through the through hole 500 of the bracket 100 and the strip-shaped slot 411 of the telescopic rod 410, and is capable of locking the telescopic rod 410 to the bracket 100. During adjustment, the locking knob 420 is loosened so that the telescopic rod 410 can slide relative to the locking knob 420 and the bracket 100 through the strip-shaped slot 411. After the telescopic rod 410 expands or retracts relative to the bracket 100 to the desired angular position, the locking knob 420 is tightened to fix the telescopic rod 410 to the bracket 100, thereby adjusting the included angle of the bracket 100 relative to the horizontal plane.

In another embodiment, the angle adjusting assembly 400 includes a supporting foot 430, an adjustment disk 440, and a pivot shaft 450. The adjustment disk 440 is fixedly disposed on the bracket 100. The supporting foot 430 is rotatably connected to the adjustment disk 440 via the pivot shaft 450, so that the supporting foot 430 can be unfolded or folded relative to the bracket 100. The adjustment disk 440 is provided with an arc-shaped guide slot 441 centered on the pivot shaft 450. A plurality of positioning recesses 442 are arranged at intervals along the circumferential direction of the arc-shaped guide slot 441. The supporting foot 430 is provided with a locking portion 460. The locking portion 460 is disposed through the arc-shaped guide slot 441 and engages with the corresponding positioning recess 442 when the supporting foot 430 rotates to a preset angle, so as to lock the unfolding angle of the supporting foot 430 relative to the bracket 100. By selecting different positioning recesses 442, the supporting foot 430 can be locked at different unfolding angles.

In yet another embodiment, the angle adjusting assembly 400 includes a hinge shaft 470, an adjustment groove 480, and a fixing knob 490. The bracket 100 includes a base bracket 160 and a movable bracket 170 that are hinged via the hinge shaft 470. The adjustment groove 480 is provided at one end of the base bracket 160 adjacent to the hinge position. The fixing knob 490 is disposed through the adjustment groove 480 and is connected to the movable bracket 170. The movable bracket 170 is capable of rotating relative to the base bracket 160 about the hinge shaft 470, so as to adjust the unfolding angle of the movable bracket 170 relative to the base bracket 160. After the movable bracket 170 is adjusted to a desired angle, the movable bracket 170 can be fixed at the current angle through the cooperation of the fixing knob 490 and the adjustment groove 480. The massage assembly 200 and the sliding seat 300 may be disposed on the movable bracket 170, so that the massage assembly 200 and the sliding seat 300 jointly adjust the angle along with the movable bracket 170.

When using the massage device, the user can adjust the mounting position of the massage assembly 200 on the bracket 100 according to the body part to be massaged, and can also adjust the included angle between the bracket 100 and the horizontal plane through the angle adjusting assembly 400. Subsequently, the user places the supporting part of the human body on the sliding seat 300 and makes the body part to be massaged abut against the massage assembly 200. The user can drive the sliding seat 300 to reciprocate relative to the bracket 100 by applying slight force with the body, thereby generating relative motion between the human body and the massage assembly 200. Since the sliding seat 300 provides a supporting point for the human body and the bracket 100 guides the sliding direction, the user can complete the back-and-forth movement in a relatively stable supporting state, which reduces the problem in the use of traditional massage rollers that requires additional force to maintain balance and support the body, thereby improving the stability, smoothness, and comfort of the massage or stretching process.

The above descriptions are merely preferred embodiments of the present disclosure and are not intended to limit the patent scope of the present disclosure. Any equivalent structures or equivalent process transformations made by utilizing the contents of the description and the accompanying drawings of the present disclosure, or any direct or indirect applications thereof in other relevant technical fields, shall all be similarly included within the scope of patent protection of the present disclosure.

What is claimed is:

1. A massage device, comprising:
a bracket;
a massage assembly mounted on the bracket, the massage assembly is configured to massage a body part to be massaged of a human body;
a sliding seat slidably connected with the bracket, the sliding seat is configured to support a supporting part of the human body;
wherein the sliding seat is configured to slide back and forth relative to the massage assembly, when the supporting part of the human body rests on the sliding seat and the body part to be massaged contacts the massage assembly, relative motion between the body part to be massaged and the massage assembly is generated to massage or stretch the body part to be massaged.

2. The massage device according to claim 1, wherein the bracket comprises a slide rail guide portion along a first direction, and the massage assembly comprises a sliding block slidably connected to the slide rail guide portion, whereby a mounting position of the massage assembly is adjustable along the first direction of the bracket.

3. The massage device according to claim 1, wherein the bracket is provided with a plurality of positioning portions, the massage assembly further comprises a clamping portion configured to detachably engage with any one of the plurality of positioning portions.

4. The massage device according to claim 1, wherein the massage assembly further comprises a rotating shaft, and the massage assembly is rotatably mounted on the bracket through the rotating shaft.

5. The massage device according to claim 4, wherein the massage assembly further comprises at least one massage roller.

6. The massage device according to claim 4, wherein a plurality of massage protrusions are provided on an outer periphery of the massage assembly.

7. The massage device according to claim 1, wherein the bracket is provided with a guide rail, and the sliding seat comprises a mounting portion on a side facing the bracket, the mounting portion being slidably engaged with the guide rail.

8. The massage device according to claim 1, further comprising an angle adjusting assembly configured to selectively adjust at least one of:
an inclination angle of the massage assembly relative to a horizontal plane; and
an inclination angle of the sliding seat relative to the horizontal plane.

9. The massage device according to claim 8, wherein the angle adjusting assembly is disposed at one end of the bracket proximate to the sliding seat.

10. The massage device according to claim 8, wherein the angle adjusting assembly comprises a telescopic rod and a locking knob;
wherein the telescopic rod defines a strip-shaped slot extending along a length direction thereof;
the bracket defines a through hole aligned with the strip-shaped slot;
the locking knob passes through the through hole and the strip-shaped slot to selectively lock the telescopic rod at different extension lengths relative to the bracket.

11. The massage device according to claim 8, wherein the angle adjusting assembly comprises a supporting foot, an adjustment disk fixed to the bracket, and a pivot shaft;
wherein the supporting foot is rotatably connected with the adjustment disk via the pivot shaft, the supporting foot being configured to pivot relative to the bracket between an expanded position and a retracted position.

12. The massage device according to claim 11, wherein the adjustment disk defines an arc-shaped guide slot centered on the pivot shaft, the arc-shaped guide slot being provided with a plurality of positioning recesses spaced apart along a circumferential direction;
wherein the supporting foot comprises a locking portion configured to selectively engage any one of the plurality of positioning recesses through the arc-shaped guide slot, thereby locking the supporting foot in the expanded position at a desired angular position relative to the bracket.

13. The massage device according to claim 8, wherein the angle adjusting assembly further comprises a hinge shaft, an adjustment groove and a fixing knob;
the bracket further comprises a base bracket and a movable bracket hinged by the hinge shaft;
wherein the adjustment groove is provided at one end of the base bracket close to a hinge position, and the fixing knob extends through the adjustment groove and is connected with the movable bracket.

14. The massage device according to claim 11, wherein the bracket further comprises a supporting frame, and the massage assembly is mounted on the supporting frame so as to form a gap between the massage assembly and the horizontal plane.
